(19) United States
(12) Patent Application Publication
(10) Pub. No.: US 2026/0204180 A1
(43) Pub. Date: Jul. 16, 2026

(54) TELEMATICS-BASED FEEDBACK FOR IMPROVING A DRIVING SKILL

(71) Applicant: Quanata, LLC, San Francisco, CA (US)

(72) Inventor: Chad Fred Lott, Richmond, CA (US)

(73) Assignee: Quanata, LLC, San Francisco, CA (US)

(21) Appl. No.: 19/022,606

(22) Filed: Jan. 15, 2025

(51) Int. Cl. G09B 19/16; B60W 40/09

(52) U.S. Cl. CPC G09B 19/167; B60W 40/09

(57) ABSTRACT

A method can include receiving telematics data from one or more sensors of an electronic device of a user. The method can also include determining a respective skill level for each of a plurality of driving skills of the user based on the telematics data. The method can further include determining, from among the plurality of driving skills, a driving skill for the user to improve. The method can additionally include generating personalized feedback for the user. The personalized feedback is for improving the driving skill. The method can also include transmitting the personalized feedback to a mobile device of the user for display to the user. Other embodiments are disclosed.

### FIELD OF THE DISCLOSURE

The present disclosure generally relates to telematics-based feedback for improving a driving skill.

### BACKGROUND

Good driving skills benefit society by improving the safety of drivers and pedestrians around them. Many drivers do not have feedback on their driving. Those drivers that do have driving feedback often only have a one-size-fits all system, which can lack relatability, engagement, and impact for the individual driver. Such systems can be inadequate because drivers may vary when it comes to stress tolerance, motivation, and attitudes towards learning and improvement.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3;

FIG. 2 illustrates a representative block diagram of an example of the elements included in the circuit boards inside a chassis of the computer system of FIG. 1;

FIG. 3 illustrates a system for telematics-based feedback for improving a driving skill; and

FIG. 4 illustrates a flow chart for telematics-based feedback for improving a driving skill.

The figures depict preferred embodiments for purposes of illustration only. One skilled in the art will readily recognize from the following discussion that other embodiments of the systems and methods illustrated herein can be employed without departing from the principles of the embodiments described herein.

### DETAILED DESCRIPTION OF THE DRAWINGS

The present embodiments can generally relate to, inter alia, providing personalized feedback for a user. The system is capable of determining a driving score. The system is also capable of providing a reward to the user. The system is further capable of transmitting (a) the telematics data or (b) the respective skill level for at least one of the plurality of driving skills of the user to a third party.

The embodiments described in this patent application can solve one or more of the following technical problems related to providing feedback on driving skills: (1) users can receive and understand feedback in a conversational manner, improving overall user experience, (2) the ability to offer real-time dynamic feedback that can be crucial to learning while a user is driving, and/or (3) providing personalized and effective feedback that is relevant and compatible with the user. This approach can result in effective learning and improvement of driving skills for the user.

More specifically, various embodiments can include a computer-implemented method. The method can include receiving telematics data from one or more sensors of an electronic device of a user. The method can also include determining a respective skill level for each of a plurality of driving skills of the user based on the telematics data. The method can further include determining, from among the plurality of driving skills, a driving skill for the user to improve. The method also can further include generating personalized feedback for the user. The personalized feedback can be for improving the driving skill. The method can also include transmitting the personalized feedback to a mobile device of the user for display to the user. The method also can be configured to include additional, less, or other functionality, including that discussed elsewhere herein.

In other embodiments, a system can be provided. The system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, artificial intelligence bots, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, cause the one or more processors to perform one or more operations.

The operations can include receiving telematics data from one or more sensors of an electronic device of a user. The operations can also include determining a respective skill level for each of a plurality of driving skills of the user based on the telematics data. The operations can further include determining, from among the plurality of driving skills, a driving skill for the user to improve. The operations also can further include generating personalized feedback for the user. The personalized feedback can be for improving the driving skill. The operations can also include transmitting the personalized feedback to a mobile device of the user for display to the user. The system can be configured to include additional, less, or other functionality, including that discussed elsewhere herein.

In further embodiments, a non-transitory computer readable storage medium storing computing instructions can be provided. The computing instructions, when run on one or more processors, can cause the one or more processors to perform operations including receiving telematics data from one or more sensors of an electronic device of a user. The operations can also include determining a respective skill level for each of a plurality of driving skills of the user based on the telematics data. The operations can further include determining, from among the plurality of driving skills, a driving skill for the user to improve. The operations also can further include generating personalized feedback for the user. The personalized feedback can be for improving the driving skill. The operations can also include transmitting the personalized feedback to a mobile device of the user for display to the user.

Advantages will become more apparent to those skilled in the art from the following description of the preferred embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

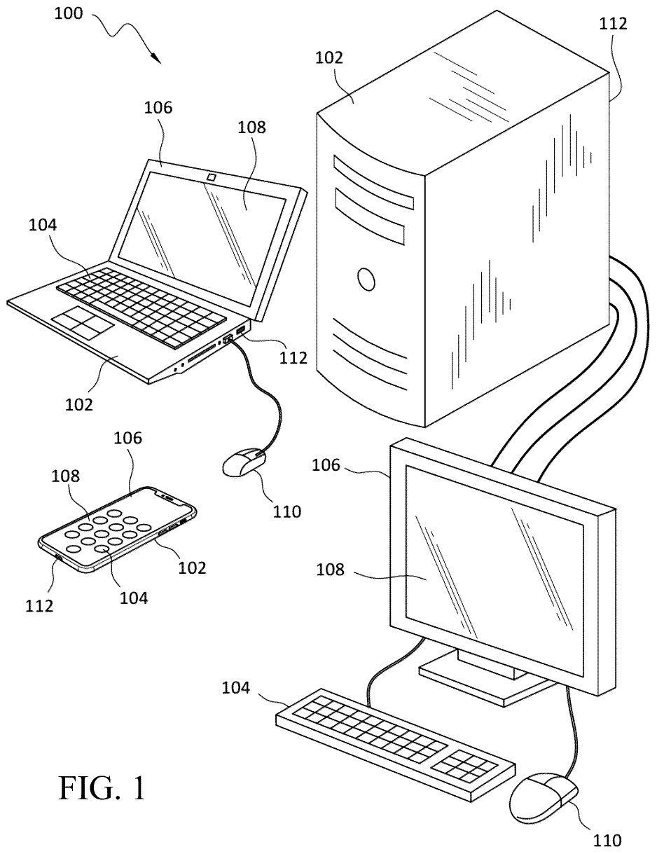

Turning to the drawings, FIG. 1 illustrates an embodiment of three different types (e.g., a laptop, a tower server, and a mobile device) a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

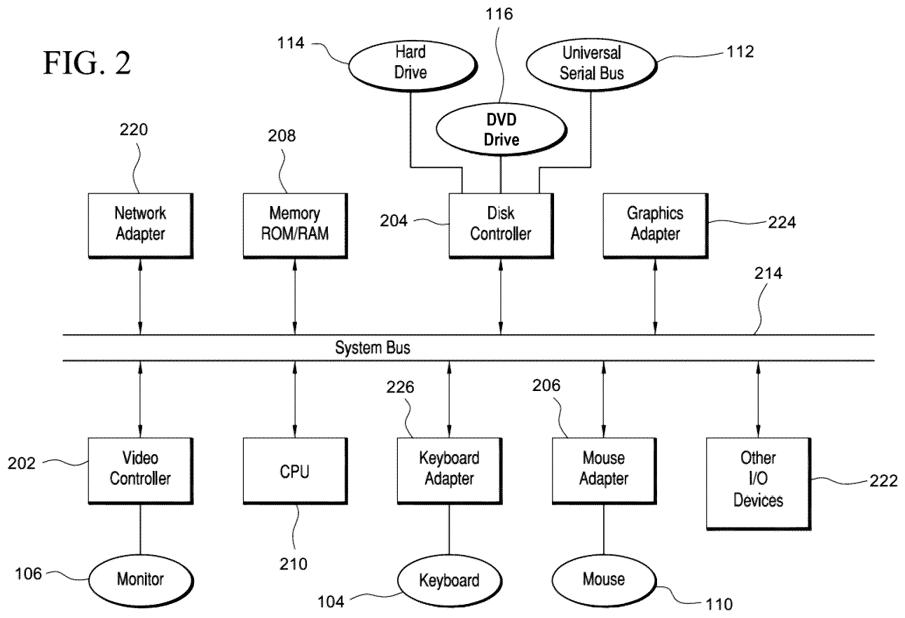

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in CD-ROM and/or DVD drive 116 (FIG. 2) inside chassis 102 (FIG. 1) or in a detachable drive coupled to input/output port 112 (FIGS. 1-2).

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable drive coupled to input/output port 112 (FIGS. 1-2), on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. In the same or different embodiment, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer, a tower server, or a mobile device in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, wearable, virtual reality headset, augmented reality glasses, etc. In certain additional embodiments, computer system 100 can comprise an embedded system.

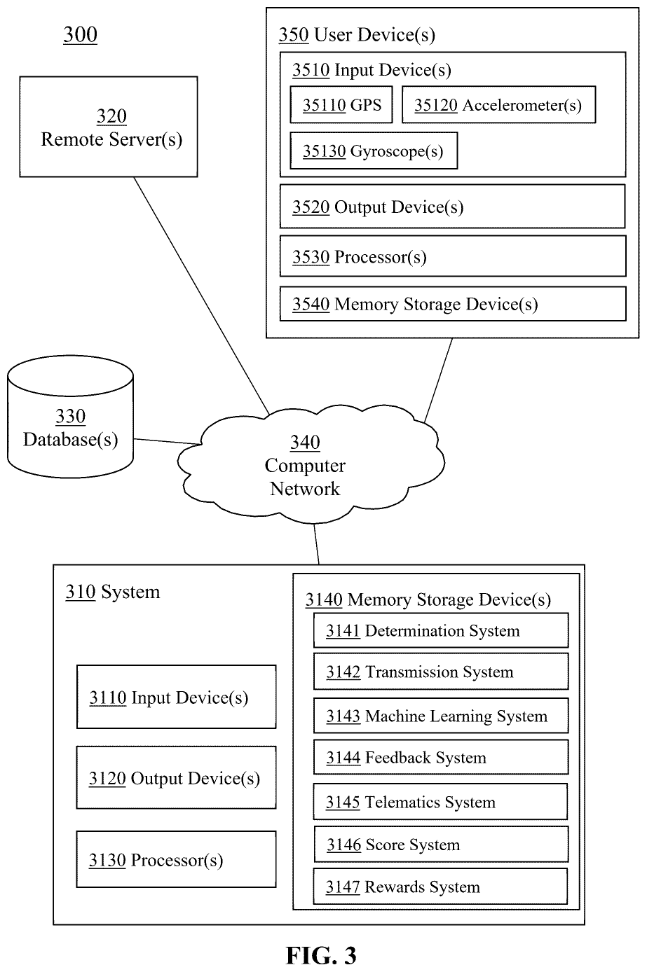

Turning ahead in the drawings, FIG. 3 illustrates a block diagram of a system 300 for telematics-based feedback for improving a driving skill, according to one embodiment. System 300 is an embodiment of the system and is not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., a system 310), remote server(s) 320, and/or one or more user devices (e.g., a user device 350). System 310 and user device 350 can each be a computer system, such as computer system 100 (FIG. 1), as described above, and can each be a single computer, a single server, or a cluster or collection of computers or servers, or a cloud of computers or servers. In another embodiment, a single computer system can host each of system 310 and user device 350.

In some embodiments, system 310 can be modules of computing instructions (e.g., software modules) stored on non-transitory computer readable media that operate on one or more processors. In other embodiments, system 310 can be implemented in hardware. In some embodiments, system 310 can comprise one or more systems, subsystems, modules, models, or servers (e.g., a determination system 3141, a transmission system 3142, a machine learning system 3143, a feedback system 3144, a telematics system 3145, a score system 3146, and a rewards system 3147, etc.). Each of determination system 3141, transmission system 3142, machine learning system 3143, feedback system 3144, telematics system 3145, score system 3146, and rewards system 3147 can be implemented, at least in part, in software and/or firmware stored in or loaded on memory storage device(s) 3140 and executed on processor(s) 3130. Additional details regarding system 310, remote server(s) 320, and user device(s) 350 are described herein.

In some embodiments, system 310 can be in data communication, through a computer network, a satellite network, a telephone network, or the Internet (e.g., computer network 340), and/or user device 350. In some embodiments, user device 350 can be used by users, such as users for system 310 and/or user device 350.

In certain embodiments, system 310 can host one or more websites and/or mobile application servers. For example, system 310 can host a website, or provide a server that interfaces with an application (e.g., a mobile application or a web browser), on user device 350. In some embodiments, an internal network (e.g., computer network 340) that is not open to the public can be used for communications between system 310, remote server(s) 320, and/or user device 350 within system 300.

In some embodiments, each of user device(s) 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3510 further can include one or more cameras and/or one or more microphones. In the same or different embodiments, input device(s) 3510 can include one or more GPS (Global Positioning System) sensor(s) (e.g., GPS sensor(s) 35110), one or more accelerometers (e.g., accelerometer(s) 35120), and/or one or more gyroscopes (e.g., gyroscope(s) 35130). In the same or different embodiments, user device(s) 350 can comprise one or more systems, subsystems, modules, models, or servers.

In some embodiments, user device 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc.

Input device(s) 3510 and output device(s) 3520 can be coupled to user device 350 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3510 and output device(s) 3520 to processor(s) 3530 and/or memory storage device(s) 3540. In some embodiments, the KVM switch also can be part of user device 350. In a similar manner, processor(s) 3530 and/or memory storage device(s) 3540 can be local and/or remote to each other.

In certain embodiments, the user devices (e.g., user device 350) can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, an augmented-reality (AR) headset, a virtual-reality (VR) headset, etc.), or another portable computer device with the capability to present audio and/or visual data (e.g., images, videos, music, etc.).

Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In some embodiments, system 310 can include: (a) one or more input devices (e.g., input device(s) 3110 such as one or more keyboards, one or more keypads, one or more pointing devices such as a computer mouse or computer mice, one or more touchscreen displays, a microphone, etc.), (b) one or more display devices (e.g., output device(s) 3120 such as one or more monitors, one or more touch screen displays, projectors, etc.), (c) one or more processors (e.g., processor(s) 3130), and/or (d) one or more memory storage devices (e.g., memory storage device(s) 3540 such as one or more internal or external memory storage units, one or more hard drives, one or more CD-ROM or DVD drives, etc.). In these or other embodiments, one or more of the input device(s) (e.g., input device(s) 3110) can be similar or identical to keyboard 104 (FIG. 1) and/or a mouse 110 (FIG. 1). Further, one or more of the display device(s) (e.g., output device(s) 3120) can be similar or identical to monitor 106 (FIG. 1) and/or screen 108 (FIG. 1). Additionally, one or more of the processors (e.g., processor(s) 3130) can be similar or identical to CPU 210 (FIG. 2). In similar or different embodiments, one or more of the memory storage devices (e.g., memory storage device(s) 3140) can be similar or identical to memory storage unit 208 (FIG. 2), external storage units coupled to input/output port 112 (FIGS. 1-2), hard drive 114 (FIG. 2), CD-ROM and/or DVD drive 116 (FIG. 2), or a detachable drive coupled to input/output port 112 (FIGS. 1-2).

The input device(s) (e.g., input device(s) 3110) and the display device(s) (e.g., output device(s) 3120) can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple the input device(s) (e.g., input device(s) 3110) and the display device(s) (e.g., output device(s) 3120) to the processor(s) (e.g., processor(s) 3130) and/or the memory storage unit(s) (e.g., memory storage device(s) 3140). In some embodiments, the KVM switch also can be part of system 310. In a similar manner, the processors and/or the non-transitory computer-readable media can be local and/or remote to each other.

Meanwhile, in some embodiments, system 310 also can be configured to communicate with one or more databases (e.g., a database(s) 330). The one or more databases can include training data for training a machine learning model, the machine learning model, the user profile (including driving skills and respective skill level of each of the driving skills), milestones, rewards, contact information of a third-party, natural language processing software, and user telematics data.

The one or more databases additionally can include one or more of trained machine learning (ML) and/or artificial intelligence (AI) models (the ML/AI models) used in system 300 and/or system 310. The one or more databases further can include training datasets for various ML/AI models, modules, or systems, etc. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases (e.g., database(s) 330) can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc. ; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

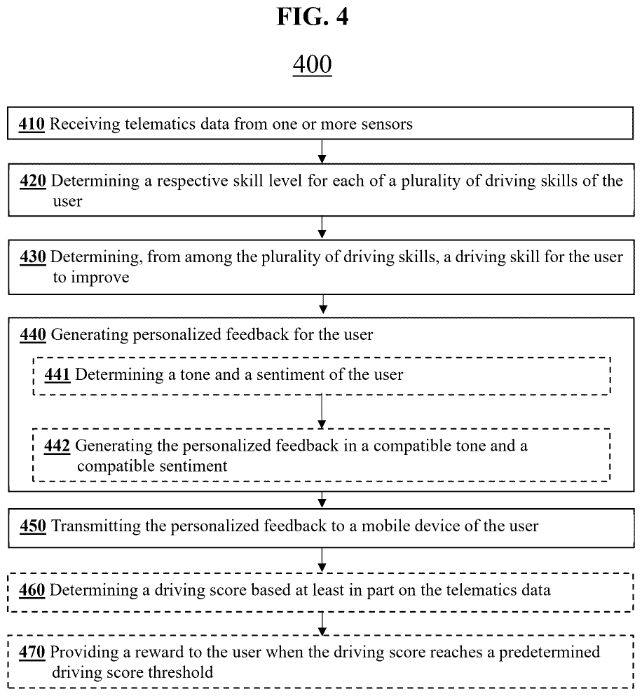

Turning ahead in the drawings, FIG. 4 illustrates actions of a method 400 for telematics-based feedback for improving a driving skill. Method 400 can be implemented via execution of computing instructions configured to run on one or more processors and stored on one or more non-transitory computer-readable media. Method 400 is an embodiment and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In some embodiments, system 300 or system 310 (FIG. 3) (including one or more of its elements, modules, and/or systems, such as determination system 3141, transmission system 3142, machine learning system 3143, feedback system 3144, telematics system 3145, score system 3146, and rewards system 3147, etc.) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300 or system 310. The processor(s) can be similar or identical to the processor(s) described above with respect to computer system 100 (FIG. 1).

Referring to FIG. 4, in some embodiments, method 400 can include a block 410 of receiving telematics data from one or more sensors. In some embodiments, the telematics data can be transmitted by a mobile electronic device (e.g., one of user device(s) 350 (FIG. 3)) of a user who is driving a vehicle. In these embodiments, the user can authorize an app on the mobile electronic device to use sensors (e.g., GPS sensors) on the mobile electronic device to collect the telematics data during a vehicle trip. The user can authorize the app to use the sensors to collect the telematics data before the vehicle trips begins or at the beginning of the vehicle trip. In other embodiments, the app automatically uses the sensors to collect the telematics data during the vehicle trip, and does not require the user to authorize the app to do so. In still other embodiments, the telematics data can be transmitted by the vehicle being driven by the user. Regardless of the source of the telematics data, the telematics data can be received directly from the source or indirectly from the source through the Internet and/or a cellular network. The telematics data can include GPS data such as speed, acceleration, deceleration, elevation, incline, decline, etc.

In some embodiments, method 400 further can include a block 420 of determining a respective skill level for each of a plurality of driving skills of the user. The driving skills can include a steering skill, a braking skill, a speeding skill, and/or a focus skill. The steering skill can involve evaluating from the driver's telematics data, how frequently the driver makes abrupt steering corrections, how smooth the driver handles the vehicle in a turn, how well the driver maintains in his lane, and how well the driver navigates a corner. The braking skill can involve evaluating from the driver's telematics data, how smoothly the driver brakes. Sudden braking can lower the braking skill as it can increase the chances of the driver being rear ended or indicate that the driver is tailgating the vehicle in front of him. The speeding skill can involve evaluating how quickly the driver accelerates and/or whether the driver drives at a speed around (e.g., +/−10 units within the speed limit) or below the speed limit. The focus skill can involve evaluating the driver's focus. In some embodiments, the driver's focus can be evaluated by tracking the driver's phone usage while the driver is driving. For example, if the driver is building a music playlist while he is driving his focus skill be negatively impacted. In some other embodiments, the driver's focus can be tracked by the volume of the music the driver is playing from his mobile device or from the infotainment of the vehicle. In some embodiments, the system can differentiate whether the driver is accessing the phone directly or using the infotainment center connected to the phone in order to evaluate the focus skill.

The determining of the driving skills can be adjusted for the context. For example, if the telematics data is collected during a traffic jam or while the driver is driving through a construction zone, such data collected may have less effects on determining the driving skill or be omitted entirely.

In some embodiments, the skill levels of the driving skills can use a comparative analysis approach, where the driver's performance is compared against a dataset of other drivers. The other drivers can be selected from a demographic similar to that of the driver. In other embodiments, the driver's performance can be compared to that of an average driver that can be determined from a national dataset. The skill levels can be cumulative (e.g., a system where the user can de-rank for low performance) or a system that is not cumulative (e.g., the user is able to de-rank).

In a number of embodiments, method 400 also can include a block 430 of determining, from among the plurality of driving skills, a driving skill for the user to improve. In some embodiments, the driving skill for the user to improve can be the lowest ranked skill of the driving skills. For example, if the driver has a higher skill level in the steering skill, braking skill, and focus skill, but a lower skill level when it comes to the speeding skill, the speeding skill can be determined to be the driving skill for the user to improve on. In other embodiments, the user can choose which skill(s) he wants to prioritize improvement on. For example, if the user has a higher skill level in the steering skill but a lower skill level in the braking skill, the focus skill, and the speeding skill, the steering skill can be determined to be the driving skill for the user to improve on because that is the skill the user has chosen to improve on. In various embodiments, the driving skill for the user to improve on can be selected be determined by the system in real-time through a third-party. Third-parties can be a parent, a driving instructor/school, and/or an automobile insurance company. Third-parties can also include the government (e.g., a state department) For example, the driving instructor/school can select the steering skill to be the driving skill for the user to improve on because the user is the driving instructor's student, and the instructor believes the student needs to improve on the steering skill. In another example, the driving instructor/school can select the steering skill to be the driving skill for the user to improve on because the user is a student in the driving instructor's class and the students in the instructor's class need to improve on the steering skill. In yet another example, the insurance company can select the speeding skill for the user to improve on because the insurance company has found that the user has been disciplined by a jurisdiction for not following the speed limit rules through their driving record or because other users in the same geographical location as the user have a tendency of not following the speed limit rules of the jurisdiction.

In some embodiments, the personalized feedback of all or certain users in the same geographical region may receive similar personal feedback. For example, users in the certain region may be overrepresented in car accidents so their feedback may have an emphasis on constructive feedback. Users in other regions may be considered safe drivers and their feedback may have an emphasis on positive reinforcement. The driving skill to be improved by the driver via the personalized feedback can also be similarly customized.

In some embodiments, method 400 further can include a block 440 of generating personalized feedback for the user. The personalized feedback can include practical tips and guidance for the user based on a selected driving skill or the driving skill that the user is to improve on determined in block 430. For example, practical tips for steering can include adjusting the seat into a comfortable position so that steering does not feel awkward for the user, adjusting the mirrors so that the user does not need to lean up from their seat to check a mirror to safely make a lane change, etc.

In some embodiments, block 440 can further include a block 441 of determining a tone and a sentiment of the user. The mobile device of the user can listen to the user as he is driving and convert the speech of the user into text. The text can then be tokenized into smaller units such as words or phrases. Part-of-speech tagging can be performed to assign grammatical roles to each token to identify each token as a noun, verb, adjective, etc. Syntactic parsing can then be performed on the tokens to analyze the grammatical structure of the sentences to establish relationships between the words and phrases.

Semantic analysis can be performed on the tokens to determine the meaning of the speech. Semantic analysis can include recognizing named entities or lack of, including proper nouns such as names of individuals, organizations, and locations. Semantic analysis can also include sentiment analysis which utilizes a machine learning model trained on large datasets to classify text as positive, negative, or neutral. Linguistic patterns and contextual cues can be used to identify emotional nuances such as sarcasm and irony.

In some embodiments, the volume of the user's speech can be further factored in to determine the tone and sentiment of the user. For example, the volume of the user's speech can be compared to an average volume of the user's speech and a louder than average volume may indicate that the user is irate and a lower than average volume may indicate that the user is calm.

In some embodiments, block 440 can further include a block 442 of generating the personalized feedback in a compatible tone and a compatible sentiment. Based on the determinations made in block 441, personalized feedback can be generated in a compatible tine and a compatible sentiment using natural language generation to produce human-like text. For example, if the user is expressing frustration with the traffic, the compatible tone may be empathetic, and the sentiment may be neutral. In another example, if the user is feeling joyous, the tone be casual, and the sentiment can be positive.

In some embodiments, the compatible tone and compatible sentiment may can further depend on the telematics data of the driver (user). If the user has been swerving and/or driving beyond the speed limitation, the compatible tone may be stern, and the sentiment may be negative. In other embodiments, the tone and sentiment can be set by a user or a third-party and remain static.

In some embodiments, method 400 further can include a block 450 of transmitting the personalized feedback to a mobile device of the user. The transmitted feedback can be displayed on the mobile device of the user or be played through the mobile device of the user in a way that does not distract the user. For example, the feedback may be played in audio form on the mobile device without waking up the screen. The feedback can be displayed or played at the end of a user's trip or as the user is driving.

In some embodiments, method 400 further can include a block 460 of determining a driving score based at least in part on the telematics data. In various embodiments, individual scores determined from an analysis of the sensor data may be aggregated and/or combined in any suitable manner, such as by adding the scores, multiplying the scores, averaging the scores, assigning a weight to each score and adding or multiplying the weighted scores, taking a weighted average of the scores, etc., to determine an overall driver assessment. For example, the data in each of the sets of sensor data used to calculate a driver assessment may be weighted for example, such that sensor data for more recent historic trips is weighted more heavily than the other sets of sensor data. To provide another example, each of the sets of sensor data may be weighted equally.

In some embodiments, method 400 further can include a block 470 of providing a reward to the user when the driving score reaches a predetermined driving score threshold. In various embodiments, the reward can include a discount for a vehicle insurance premium, a different monetary incentive, a reward internal to an app on the mobile electronic device (e.g., a boost to the driving score, a boost to the skill level of a driving skill, a dashboard or skin that imitates a luxury car or sports car), a reward external to that app (e.g., unlocking a playlist), etc. The reward can be part of a gamification system to motivate the user to continue using the application, where the gamification system relies on the user's loss aversion tendencies or desires. In the same or different embodiments, a streak milestone system can include a check-in system where the user can indicate that he has not driven on a certain day. The check-in system can provide daily rewards.

In some embodiments, the telematics data or the respective skill level for the plurality of driving skills of the user can be transmitted to a third-party. The third-party can include one or more of a parent, a driving instructor, and/or an automobile insurance company. The transmitting of the telematics data or the respective skill level for the plurality of driving skills of the user can happen on a daily, weekly, or monthly basis. The transmitting of the telematics data or the respective skill level for the plurality of driving skills of the user can be transmitted on demand by the third-party. In some embodiments, the third-party can be notified when the user performs certain actions such as hard braking, tight turns, speeding, rapid acceleration, etc.

Relating FIG. 4 to FIG. 3, as an example, determination system 3141 (FIG. 3) and other parts of system 310 can perform all or a portion of blocks 420 and 430; transmission system 3142 (FIG. 3) and other parts of system 310 can perform all or a portion of block 450; machine learning system 3143 (FIG. 3) and other parts of system 310 can determine a tone and sentiment of the user and generate personalized feedback in a compatible tone and compatible sentiment; feedback system 3144 (FIG. 3) and other parts of system 310 can perform all or a portion of block 440; telematics system 3145 (FIG. 3) and other parts of system 310 can perform block 410; score system 3146 (FIG. 3) and other parts of system 310 can perform all or a portion of block 460; and rewards system 3147 (FIG. 3) and other parts of system 310 can perform all or a portion of block 470.

In many embodiments, the systems and/or methods can use one or more ML/AI models to perform one or more of the above-mentioned procedures, processes, activities, actions, operations, and/or methods. Further, the systems and/or methods can use one or more natural language processing (NLP) models for processing the one or more inputs and/or outputs (e.g., interpreting user feedback). Examples of the algorithms used for the various ML/AI models can include BERT, LLM, Lambda, Palm, XLNet, GPT-3, GPT-4, KNN, decision trees, linear regression, K-Means, neural networks, fuzzy logic, GANs, CTGAN, CNNs, VAEs, and so forth. In various embodiments, each of the ML/AI models used can be trained dynamically and/or regularly.

In many embodiments, the systems and/or methods can be configured to train or re-train the one or more ML/AI models. The training of each of the ML/AI models can be supervised, semi-supervised, and/or unsupervised, which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)).

In some embodiments, the systems, methods, and/or system users (e.g., a data scientist) further can determine whether to add the newly-created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

Various embodiments can include a method that can be implemented via execution of computing instructions configured to run on one or more processors and stored on one or more non-transitory computer-readable media. The method can include receiving telematics data from one or more sensors of an electronic device of a user. The method can also include determining a respective skill level for each of a plurality of driving skills of the user based on the telematics data. The plurality of driving skills can comprise at least one of: a steering skill, a braking skill, a speeding skill, and a focus skill. The method can further include determining, from among the plurality of driving skills, a driving skill for the user to improve. The method also can further include generating personalized feedback for the user. The personalized feedback is for improving the driving skill. Generating the personalized feedback for the user can comprise determining a tone and a sentiment of the user, using natural language processing, and generating the personalized feedback in a compatible tone and compatible sentiment using a machine learning model. The machine learning mode can be calibrated by the user and the machine learning model can be further calibrated through interactions with the user.

The method can also include transmitting the personalized feedback to a mobile device of the user for display to the user.

In some embodiments, the method can further include determining a driving score based at least in part on the telematics data. In some embodiments, the method can also include providing a reward to the user when the driving score reaches a predetermined driving score threshold. In certain embodiments, the driving score is reset at a predetermined interval of time. For example, the driving score can be reset on a daily basis, a weekly basis, every predetermined number of days/weeks, and/or a monthly basis. In some embodiments, the user can receive a boost in the accumulation of their driving score back to the score he had before the reset. For example, the user may find that it takes less time or less driving to return back to the score he was at prior to the reset. In a number of embodiments, (a) the telematics data or (b) the respective skill level for at least one of the plurality of driving skills of the user is transmitted to a third-party comprising one or more of a parent, a driving instructor, and/or an automobile insurance company.

Various embodiments further can include a system comprising one or more processors; and one or more non-transitory computer-readable media storing computing instructions. In many embodiments, the computing instructions, when run on the one or more processors, can cause the one or more processors to perform operations. The operations can include receiving telematics data from one or more sensors of an electronic device of a user. The operations can also include determining a respective skill level for each of a plurality of driving skills of the user based on the telematics data. The plurality of driving skills can comprise at least one of: a steering skill, a braking skill, a speeding skill, and a focus skill. The operations can further include determining, from among the plurality of driving skills, a driving skill for the user to improve. The operations also can further include generating personalized feedback for the user. The personalized feedback is for improving the driving skill. Generating the personalized feedback for the user can comprise determining a tone and a sentiment of the user, using natural language processing, and generating the personalized feedback in a compatible tone and compatible sentiment using a machine learning model. The machine learning mode can be calibrated by the user and the machine learning model can be further calibrated through interactions with the user. The operations can also include transmitting the personalized feedback to a mobile device of the user for display to the user.

In some embodiments, the operations can further include determining a driving score based at least in part on the telematics data. In some embodiments, the operations can also include providing a reward to the user when the driving score reaches a predetermined driving score threshold. In certain embodiments, the driving score is reset at a predetermined interval of time. In a number of embodiments, (a) the telematics data or (b) the respective skill level for at least one of the plurality of driving skills of the user is transmitted to a third-party comprising one or more of a parent, a driving instructor, and/or an automobile insurance company.

Various embodiments further can include a non-transitory computer readable storage medium storing computing instructions, the computing instructions, when run on one or more processors, causing the one or more processors to perform operations. The operations can include receiving telematics data from one or more sensors of an electronic device of a user. The operations can also include determining a respective skill level for each of a plurality of driving skills of the user based on the telematics data. The plurality of driving skills can comprise at least one of: a steering skill, a braking skill, a speeding skill, and a focus skill. The operations can further include determining, from among the plurality of driving skills, a driving skill for the user to improve. The operations also can further include generating personalized feedback for the user. The personalized feedback is for improving the driving skill. Generating the personalized feedback for the user can comprise determining a tone and a sentiment of the user, using natural language processing, and generating the personalized feedback in a compatible tone and compatible sentiment using a machine learning model. The machine learning mode can be calibrated by the user and the machine learning model can be further calibrated through interactions with the user. The operations can also include transmitting the personalized feedback to a mobile device of the user for display to the user.

In some embodiments, the operations can further include determining a driving score based at least in part on the telematics data. In some embodiments, the operations can also include providing a reward to the user when the driving score reaches a predetermined driving score threshold. In certain embodiments, the driving score is reset at a predetermined interval of time. In a number of embodiments, (a) the telematics data or (b) the respective skill level for at least one of the plurality of driving skills of the user is transmitted to a third-party comprising one or more of a parent, a driving instructor, and/or an automobile insurance company.

Although a system, method, and non-transitory computer readable storage medium storing computer instructions for improving a driving skill has been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIG. 1-4 can be modified, and that the foregoing discussion of certain of these embodiments does not necessarily represent a complete description of all possible embodiments. Additionally, one or more of the procedures, processes, operations, actions, and/or activities of the method in FIG. 4 can include different procedures, processes, actions, and/or activities and be performed by many different modules, in many different orders. As another example, the modules, models, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method comprising:
receiving telematics data from one or more sensors of an electronic device of a user;
determining a respective skill level for each of a plurality of driving skills of the user based on the telematics data;
determining, from among the plurality of driving skills, a driving skill for the user to improve;
generating personalized feedback for the user, wherein the personalized feedback is for improving the driving skill; and
transmitting the personalized feedback to a mobile device of the user for display to the user.

2. The computer-implemented method of claim 1, further comprising:
determining a driving score based at least in part on the telematics data; and
providing a reward to the user when the driving score reaches a predetermined driving score threshold.

3. The computer-implemented method of claim 2, wherein the driving score is reset at a predetermined interval of time.

4. The computer-implemented method of claim 1, wherein (a) the telematics data or (b) the respective skill level for at least one of the plurality of driving skills of the user is transmitted to a third-party comprising one or more of:
a parent;
a driving instructor; or
an automobile insurance company.

5. The computer-implemented method of claim 1, wherein the plurality of driving skills comprise at least one of:
a steering skill;
a braking skill;
a speeding skill; or
a focus skill.

6. The computer-implemented method of claim 1, wherein generating the personalized feedback for the user comprises:
determining a tone and a sentiment of the user, using natural language processing; and
generating the personalized feedback in a compatible tone and compatible sentiment using a machine learning model,
wherein:
the machine learning model is calibrated by the user; and
the machine learning model is further calibrated through interactions with the user.

7. The computer-implemented method of claim 1, wherein the personalized feedback is based in part on a geographical region of the user.

8. A system comprising:
one or more processors; and
one or more non-transitory computer-readable media storing computing instructions that, when executed on the one or more processors, cause the one or more processors to perform operations comprising:
receiving telematics data from one or more sensors of an electronic device of a user;
determining a respective skill level for each of plurality of a driving skills of the user based on the telematics data;
determining, from among the plurality of driving skills, a driving skill for the user to improve;
generating personalized feedback for the user, wherein the personalized feedback is for improving the driving skill; and
transmitting the personalized feedback to a mobile device of the user for display to the user.

9. The system of claim 8, wherein the operations further comprise:
determining a driving score based at least in part on the telematics data; and
providing a reward to the user when the driving score reaches a predetermined driving score threshold.

10. The system of claim 9, wherein the driving score is reset at a predetermined interval of time.

11. The system of claim 8, wherein (a) the telematics data or (b) the respective skill level for at least one of the plurality of driving skills of the user is transmitted to a third-party comprising one or more of:
a parent;
a driving instructor; or
an automobile insurance company.

12. The system of claim 8, wherein the plurality of driving skills comprise at least one of:
a steering skill;
a braking skill;
a speeding skill; or a focus skill.

13. The system of claim 8, wherein generating the personalized feedback for the user comprises:
determining a tone and a sentiment of the user, using natural language processing; and
generating the personalized feedback in a compatible tone and compatible sentiment using a machine learning model,
wherein:
the machine learning model is calibrated by the user; and
the machine learning model is further calibrated through interactions with the user.

14. The system of claim 8, wherein the personalized feedback is based in part on a geographical region of the user.

15. A non-transitory computer readable storage medium storing computing instructions that, when run on a processor, cause the processor to perform operations comprising:
receiving telematics data from one or more sensors of an electronic device of a user;
determining a respective skill level for each of a plurality of driving skills of the user based on the telematics data;
determining, from among the plurality of driving skills, a driving skill for the user to improve;
generating personalized feedback for the user, wherein the personalized feedback is for improving the driving skill; and
transmitting the personalized feedback to a mobile device of the user for display to the user.

16. The non-transitory computer readable storage medium of claim 15, wherein:
the operations further comprise:
determining a driving score based at least in part on the telematics data; and
providing a reward to the user when the driving score reaches a predetermined driving score threshold; and
the driving score is reset at a predetermined interval of time.

17. The non-transitory computer readable storage medium of claim 15, wherein (a) the telematics data or (b) the respective skill level for at least one of the plurality of driving skills of the user is transmitted to a third-party comprising one or more of:
a parent;
a driving instructor; or
an automobile insurance company.

18. The non-transitory computer readable storage medium of claim 15, wherein the plurality of driving skills comprise at least one of:
a steering skill;
a braking skill;
a speeding skill; or
a focus skill.

19. The non-transitory computer readable storage medium of claim 15, wherein generating the personalized feedback for the user comprises:
determining a tone and a sentiment of the user, using natural language processing; and
generating the personalized feedback in a compatible tone and compatible sentiment using a machine learning model,
wherein:
the machine learning model is calibrated by the user; and
the machine learning model is further calibrated through interactions with the user.

20. The non-transitory computer readable storage medium of claim 15, wherein the personalized feedback is based in part on a geographical region of the user.
